(19) United States
(12) Patent Application Publication
(10) Pub. No.: US 2006/0162784 A1
(43) Pub. Date: Jul. 27, 2006

(54) Locking valve

(76) Inventor: Julio Umansky, Santa Monica, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/040,867

(22) Filed: Jan. 21, 2005

(51) Int. Cl. F16K 35/06

(52) U.S. Cl. 137/383

(57) ABSTRACT

A faucet assembly comprises a housing having a first port and a second port. A channel passes through the housing from the first port to the second port. The faucet assembly further comprises a plug positioned within the housing. The plug is movable between a first position and a second position. When the plug is in the first position the first port is fluidly connected to the second port, and when the plug is in the second position the channel is occluded. The faucet assembly further comprises an actuator that is at least partially positioned outside the housing. The actuator is configured to move the plug between the first and second positions. The faucet assembly further comprises a locking mechanism that is movable between a locked position and an unlocked position. When the locking mechanism is in the locked position the actuator is immobilized. When the locking mechanism is in the unlocked position the actuator can move the plug between the first and second positions.

### FIELD OF THE INVENTION

The present invention relates generally to a valve used to control fluid flow, and more specifically to a valve assembly capable of being locked in a closed or open position.

### BACKGROUND OF THE INVENTION

Water faucets are often placed in public locations where access to the faucet cannot be controlled, thereby exposing the faucet to tampering, vandalism and unauthorized use. For example, apartment buildings often have water faucets placed in public locations, such as around the perimeter of the building, or in semi-public locations, such as in common or garage areas. In such situations, the water faucet can be adapted to include a locking mechanism, so that a key or other device is required to draw water from the faucet. In one conventional configuration, a lock is placed over the end of the faucet, thereby preventing access to the faucet without prior removal of the lock. In another conventional configuration, the faucet plug is locked in place, and cannot be moved without use of a key. These and other arrangements can reduce or eliminate unauthorized use of the water faucet in some situations.

### SUMMARY OF THE INVENTION

Although several locking mechanisms for water faucets have been developed, many conventional designs suffer from disadvantages. For example, in a configuration wherein a separate locking cap is placed over the end of a faucet, the faucet can be subject to unauthorized use if the lock is removed from the faucet, or if an authorized user forgets to replace the lock after use. In addition, the locking cap can easily be misplaced once it has been removed. An improved locking valve assembly has been developed that addresses certain disadvantages of conventional locking faucet configurations. For example, in one embodiment, the improved locking valve assembly disclosed herein is positioned upstream from the faucet, such that removal of the locking valve will assembly also result in removal of the faucet itself. Further, the lock is integral to the valve, so optionally there is not a separate lock or locking cap that can be easily lost. The valve lock can be a key-type lock, a combination-type lock, a magnetic-type lock, and so on.

In accordance with the foregoing, in one embodiment a faucet assembly comprises a housing having a first port and a second port. A channel passes through the housing from the first port to the second port. The faucet assembly further comprises a plug positioned within the housing. The plug is movable between a first position and a second position. When the plug is in the first position the first port is hydraulically connected to the second port, and when the plug is in the second position the channel is occluded. The faucet assembly further comprises an actuator that is at least partially positioned outside the housing. The actuator is configured to move the plug between the first and second positions. The faucet assembly further comprises a locking mechanism that is movable between a locked position and an unlocked position. When the locking mechanism is in the locked position the actuator is immobilized. When the locking mechanism is in the unlocked position the actuator can move the plug between the first and second positions.

In another embodiment, an apparatus comprises a housing having a first port configured to be secured to a fluid source and a second port configured to be secured to a spigot. A channel passes through the housing from the first port to the second port. The apparatus further comprises a plug that is supported within the housing. The apparatus further comprises a keyed lock. The keyed lock is configured such that when a key is inserted into the keyed lock and rotated, the plug is movable between a first position wherein the channel is occluded and a second position wherein the first port is hydraulically connected to the second port. The keyed lock is further configured such that when the key is removed from the keyed lock, the plug is not movable between the first and second positions.

In another embodiment, an apparatus comprises a fluid channel hydraulically connecting a first port with a second port. The apparatus further comprises a seal that is positionable in a first position wherein the seal occludes the fluid channel, and in a second position wherein the first and second ports are hydraulically connected. The apparatus further comprises a lock assembly adapted to restrict movement of the seal. When the lock assembly is in an unlocked position the seal is movable between the first and second positions, and when the lock assembly is in a locked position the seal is immobilized.

In another embodiment, a faucet assembly comprises a fluid channel hydraulically connecting a first port with a second port. The faucet assembly further comprises a plug that is movable between a first position and a second position. When the plug is in the first position the first port is hydraulically connected to the second port, and when the plug is in the second position the channel is occluded. The faucet assembly further comprises locking means for restricting movement of the plug.

In another embodiment, a method of controlling fluid flow comprises providing a faucet assembly having a fluid channel with a fluid inlet port configured to be connected to a fluid source and a fluid outlet port configured to be connected to a spigot. The method further comprises providing a plug that is positioned within the faucet assembly and that is capable of being moved between a first position and a second position with a switch. Moving the plug from the first position to the second position severs a hydraulic connection between the fluid inlet port and the fluid outlet port. The method further comprises using a key to lock a locking mechanism. Locking the locking mechanism disables the switch, thereby preventing movement of the plug between the first position and the second position.

In another embodiment, a method of manufacturing a faucet assembly comprises providing a housing having a first port and a second port. A channel passes through the housing from the first port to the second port. The method further comprises positioning a plug within the housing. The plug is movable between a closed position wherein the channel is occluded and an open position wherein the first port is hydraulically connected to the second port. The method further comprises coupling a switch to the plug. A portion of the switch is positioned outside the housing, such that actuation of the switch causes the plug to move between the open position and the closed position. The method further comprises providing a keyed lock at least partially within the housing, wherein locking the keyed lock prevents movement of the switch.

### BRIEF DESCRIPTION OF THE DRAWINGS

Exemplary embodiments of an improved locking valve assembly are illustrated in the accompanying drawings, which are for illustrative purposes only. The drawings comprise the following figures, in which like numerals indicate like parts.

FIG. 1 is a perspective view of an exemplary embodiment of a locking valve assembly.

FIG. 2 is a schematic illustration of an exemplary use for the locking valve assembly of FIG. 1.

FIG. 3 is a partial cutaway cross-sectional view of selected internal components of the locking valve assembly of FIG. 1.

FIG. 4 is an exploded view of selected components of the locking valve assembly of FIG. 1.

### DETAILED DESCRIPTION OF PREFERRED EMBODIMENTS

The present invention relates generally to a valve used to control fluid flow, and more specifically to a valve assembly capable of being locked in a closed or open position. The locking mechanism can advantageously be integral to the valve assembly, and the locking valve can optionally be positioned upstream and in fluid communication with a faucet. The faucet, by way of example, can have a threaded end for receiving a hose. The valve lock can optionally be a key-type lock, a combination-type lock, a magnetic-type lock, an electronic lock, and so on.

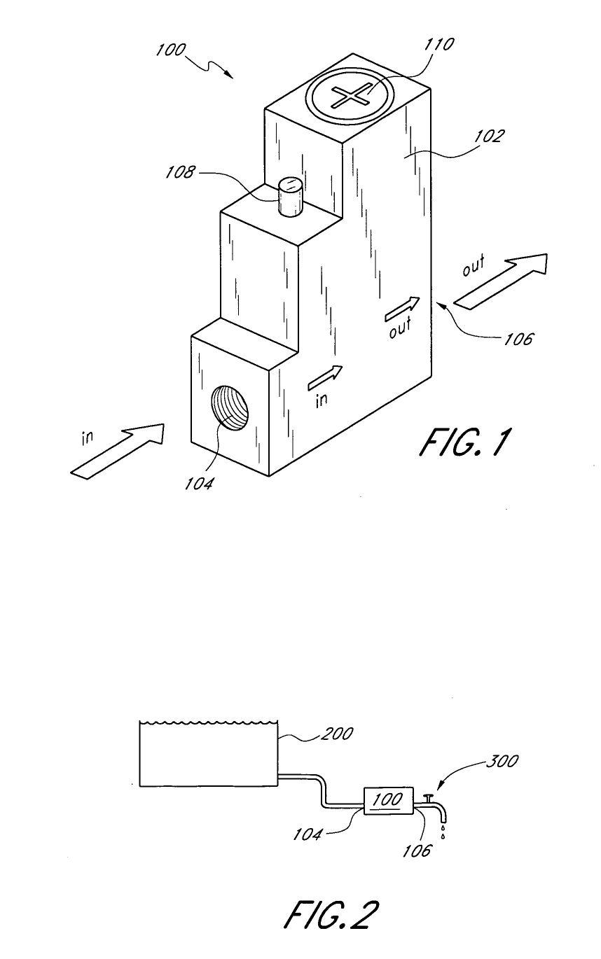

An exemplary embodiment of an improved locking valve assembly 100 is illustrated in FIG. 1. The locking valve assembly 100 includes a housing 102 having a fluid inlet port 104 and a fluid outlet port 106, a valve actuator 108, and a locking mechanism 110, which can include a key slot for receiving a key. Inside the housing 102 is a valve that can be opened or closed by pressing or releasing the actuator 108. The actuator 108 can be locked in the open or closed position using the locking mechanism 110.

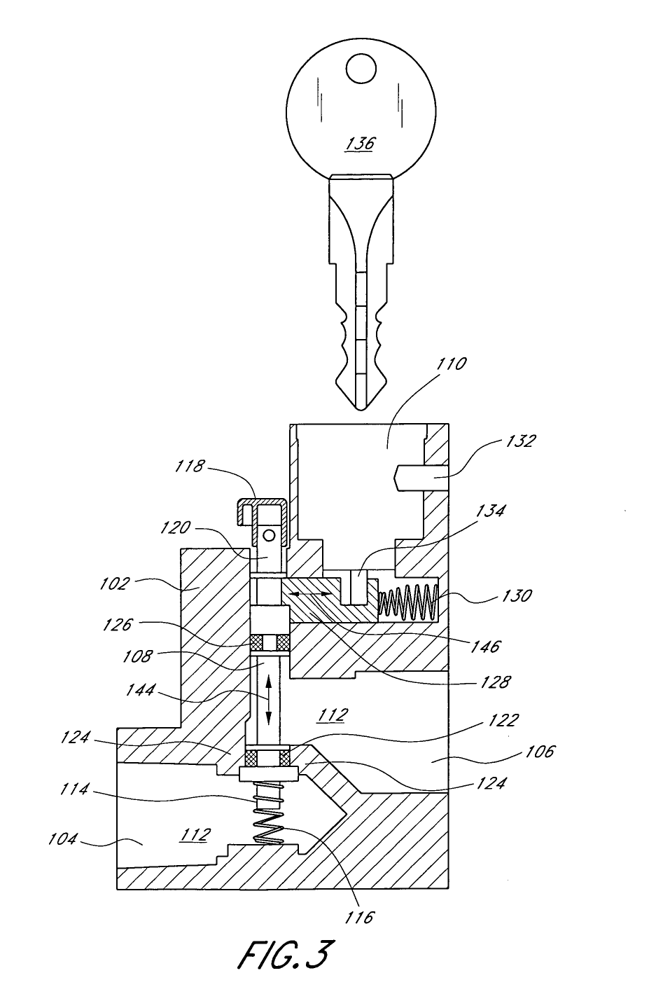

In an exemplary embodiment, illustrated schematically in FIG. 2, the inlet port 104 is fluidly coupled to a fluid source 200, and the outlet port 106 is fluidly coupled to a spigot 300. Using this example configuration, fluid supply from the fluid source 200 to the spigot 300 can be switched on or off using the valve assembly 100. For example, in one embodiment only individuals having a key capable of unlocking the locking mechanism 110 can enable fluid to flow from the fluid source 200 to the spigot 300. In an exemplary application, the fluid source 200 is a municipal water supply, and the spigot 300 is a hose bib.

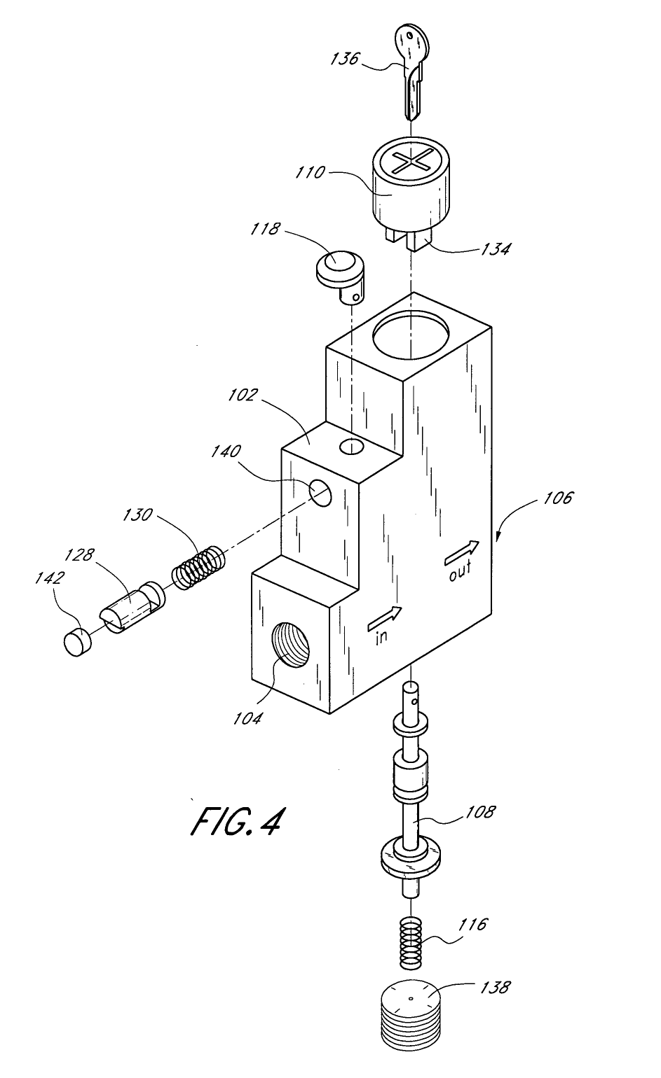

Selected internal components of the valve assembly 100 are illustrated in FIG. 3, which provides a partial cutaway cross-sectional view. As illustrated, in an exemplary embodiment a fluid channel 112 is formed in the housing 102. The fluid channel 112 includes an inlet port 104 and an outlet port 106. The inlet port 104 and outlet port 106 optionally include threads on the interior surface of the fluid channel 112, thereby allowing additional plumbing components to be attached thereto. See, for example, FIGS. 1 and 2. In a modified embodiment, the threads are formed on a fitting placed on, or extending from the exterior surface of the housing. In still other embodiments, the valve assembly 100 is connected to other plumbing components using a slip fit configuration.

Examples of additional plumbing components that can be used with the valve assembly 100 include, but are not limited, piping, hoses, reducers, hose bibs and spigots. For example, the valve assembly 100 can be positioned remotely from the spigot 300 through the use of intervening piping. Furthermore, it should be recognized that although the words “inlet” and “outlet” are used to describe the ports of fluid channel 112, fluid can be flowed through the valve assembly in either direction. Therefore, in a modified configuration, fluid is flowed into the outlet port 106, and out of the inlet port 104.

Still referring to the exemplary embodiment illustrated in FIG. 3, the housing 102 supports an elongate valve actuator 108. The valve actuator 108 has a distal end 114 that is coupled to the housing 102 via a spring 116, and has a proximal end 120 that optionally supports a pushbutton 118. In an exemplary embodiment, pressing the pushbutton 118 will cause the valve actuator 108 to slide within the housing 102 in a direction substantially perpendicular to the fluid channel 112, thereby compressing the spring 116. Such movement is indicated by arrow 144 in FIG. 3. In a modified embodiment, the pushbutton 118 is replaced with a pull tab, such that pulling the pull tab causes the valve actuator 108 is slid within the housing 102 in a direction substantially perpendicular to the fluid channel 112, thereby compressing the spring 116.

In an exemplary embodiment, two seals are coupled to the valve actuator 108. Distal seal 122 is configured to seal against an aperture portion 124 of the housing 102. In an exemplary embodiment, when the distal seal 122 is positioned within aperture portion 124, the distal seal 122 substantially prevents fluid from flowing from the inlet port 104 to the outlet port 106. As evident from FIG. 3, pressing the pushbutton 118 will cause the valve actuator 108 to move the distal seal 122 out of the housing aperture portion 124, thereby hydraulically connecting the inlet port 104 and the outlet port 106. In this way, the distal seal 122 and the housing aperture portion 124 form a valve within the housing 102.

Still referring to the exemplary embodiment illustrated in FIG. 3, when the pushbutton 118 is pressed and the distal seal 122 is moved out of the housing aperture portion 124, the spring 116 compresses. Therefore, when the pushbutton 118 is released, the spring 116 decompresses and causes the distal seal 122 to seat in the housing aperture portion 124. This configuration allows the valve formed by the distal seal 122 to be biased in the closed position. In a modified embodiment, a different spring is used, such that the valve is biased in the open position, and the pushbutton must be pulled away from the housing to close the valve. As described above, in such embodiments, the pushbutton is optionally replaced with a pull tab or other device that facilitates handing in a pulling motion.

In an exemplary embodiment, the valve actuator 108 also includes a proximal seal 126. The proximal seal 126 is configured to reduce or prevent fluid seepage from the fluid channel 112 to other internal components of the valve assembly 100. In one embodiment, the distal and proximal seals comprise a rubber gasket, although the gasket can be made from other appropriate materials in other embodiments, such as silicone, plastic and the like.

Still referring to the exemplary embodiment illustrated in FIG. 3, movement of the valve actuator is selectively restricted using stop block 128. In this embodiment, stop block 128 is movable between a first position, illustrated in FIG. 3, wherein the stop block 128 restricts movement of the valve actuator 108, and a second position, wherein movement of the valve actuator 108 is not restricted. Such movement is indicated by arrow 146 in FIG. 3. In such embodiments, the valve actuator 108 can be moved to a desired position, such as valve open or valve closed, and then the stop block 128 can be positioned to lock the valve actuator 108 in place. The stop block 128 is optionally biased in the locked position by spring 130 in the exemplary embodiment illustrated in FIG. 3. However, in other embodiments, the stop block 128 is biased in the unlocked position by using a different spring.

In an exemplary embodiment, the stop block 128 is moved between the first and second positions using the locking mechanism 110, which is secured within the housing by a screw or pin 132. The locking mechanism 110 is configured such that when an appropriate key 136 is inserted and rotated into the locking mechanism 110, dowel 134 moves in a direction perpendicular to the axis around which the key is rotated. As illustrated in FIG. 3, this motion can be used to move the stop block 136 into or from a position that restricts movement of the valve actuator 108. Therefore, the locking mechanism 110 can be used to lock the valve actuator 108 in place, either with the valve open or the valve closed, as disclosed herein.

Although a keyed lock with pins is illustrated in FIG. 3, other locking mechanisms can be used to move the stop block 128 into or from the path of the valve actuator 108. Other exemplary locking mechanisms that can be used include, but are not limited to, combination locks and electronically-controlled locks that use encoded cards, such as magnetically encoded cards or punch cards. In embodiments wherein an electronically-controlled locking mechanism is used, the locking mechanism is optionally actuated from a remote location, such as from a remotely-located computer via a command signal provided over a network. In one embodiment where a key is used to lock and unlock the valve assembly, the key is comprises a key having two perpendicular planes of engagement, such as illustrated in FIG. 3. Other embodiments can utilize a conventional flat key or a tubular key. The locking mechanism can be a pin-and-tumbler lock, a wafer tumbler lock, a tubular lock, a cam lock, a plunger lock, or other type of lock.

An exploded view of certain components of an exemplary embodiment of the valve assembly 100 is illustrated in FIG. 4. As illustrated, a distal end of the valve actuator 108 is coupled to the spring 116. The spring 116 seats against the plug 138, which forms a part of the housing 102. A proximal end of the valve actuator 108 is coupled to the pushbutton 118, which sits outside housing 102 to facilitate access thereto. As illustrated, the stop block 128 is positioned along an axis substantially perpendicular to the axis along which the valve actuator moves. The stop block 128 is coupled to spring 130, which seats against an interior portion of the housing 102. During assembly, stop block 128 and spring 130 can be inserted into housing through access hole 140, which is later sealed with plug 142. As described herein the valve assembly further includes a locking mechanism 110 having a dowel 134 that can be used to move the stop block 128. In an exemplary embodiment, dual-plane key 136 is used to lock and unlock the locking mechanism 110.

Using the configurations disclosed herein, the valve assembly can be used to control fluid flow to a spigot, as illustrated in FIG. 2. For example, the valve can be kept locked, rendering the spigot unusable except to authorized users who are given a key, combination, or other suitable means for unlocking the valve assembly. The valve assembly can be used to lock the valve in an open or closed configuration, and therefore can be used in applications where an uninterrupted fluid flow is sought. For example, for equipment that requires an uninterrupted water supply, the valve assembly disclosed here can be used to lock the water supply valve open, such that unauthorized users cannot disconnect or interrupt the water supply.

Although the various embodiments of the valve assembly disclosed herein have many applications in the context of water supply systems, it should be appreciated that the valve assembly can be used to control the flow of fluids other than water. In an exemplary embodiment, the material comprising the housing and other components of the valve assembly are selected based on the particular fluid to be passed through the fluid channel. For example, materials particularly well-suited for use with water include, but are not limited to brass, copper, aluminum, a zinc-magnesium alloy, stainless steal, and/or plastic. In particular, these materials are resistant to both corrosion and oxidation.

In an exemplary embodiment, the housing 102 is manufactured using an appropriate manufacturing technique, such as machining from solid metal blocks, such as from brass or iron stock. In other embodiments, the housing 102 is manufactured by pouring molten materials into preformed molds or by sand casting in brass or iron.

### Scope of the Invention

While the foregoing detailed description discloses several embodiments of the present invention, it should be understood that this disclosure is illustrative only and is not limiting of the present invention. It should be appreciated that the specific configurations and operations disclosed can differ from those described above, and that the methods described herein can be used in contexts other than water faucets.

I claim:

1. A faucet assembly comprising:
a housing having a first port and a second port, wherein a channel passes through the housing from the first port to the second port;
a plug positioned within the housing that is movable between a first position and a second position, wherein when the plug is in the first position the first port is hydraulically connected to the second port, and when the plug is in the second position the channel is occluded;
an actuator that is at least partially positioned outside the housing, the actuator configured to move the plug between the first and second positions; and
a locking mechanism that is movable between a locked position and an unlocked position, wherein when the locking mechanism is in the locked position the actuator is immobilized, and when the locking mechanism is in the unlocked position the actuator can move the plug between the first and second positions.

2. The faucet assembly of claim 1, wherein the locking mechanism includes a keyed lock with pins.

3. The faucet assembly of claim 1, wherein the first port and the second port have a threaded portion configured to be threadingly engaged to an additional threaded component.

4. The faucet assembly of claim 1, wherein the first port is fluidly coupled to a spigot that is positioned downstream from the plug, wherein the spigot is configured to continuously control the fluid flow rate passing there through.

5. The faucet assembly of claim 1, further comprising a spring coupled to the housing and the plug, the spring biasing the plug in the second position.

6. The faucet assembly of claim 1, further comprising a spring coupled to the housing and the plug, the spring biasing the plug in the first position.

7. The faucet assembly of claim 1, wherein the housing comprises brass.

8. The faucet assembly of claim 1, wherein the plug includes a seal configured to seat against the housing when the plug is in the second position.

9. The faucet assembly of claim 1, wherein the actuator comprises a button that, when depressed, causes the plug to move from the second position to the first position.

10. The faucet assembly of claim 1, wherein the locking mechanism is moved between the locked position and the unlocked position using a key.

11. The faucet assembly of claim 1, wherein the locking mechanism is moved between the locked position and the unlocked position using a dual-plane key.

12. The faucet assembly of claim 1, wherein the locking mechanism comprises a combination lock.

13. An apparatus comprising:
a housing having a first port configured to be secured to a fluid source and a second port configured to be secured to a spigot, wherein a channel passes through the housing from the first port to the second port;
a plug that is supported within the housing; and
a keyed lock configured such that
when a key is inserted into the keyed lock and rotated, the plug is movable by a user from a first position wherein the channel is occluded to a second position wherein the first port is fluidly connected to the second port, and
when the key is removed from the keyed lock, the plug is not movable by a user from the first position to the second position.

14. The apparatus of claim 13, wherein the housing comprises brass.

15. The apparatus of claim 13, wherein the housing comprises copper.

16. The apparatus of claim 13, wherein the housing is threadingly engaged to the spigot.

17. The apparatus of claim 13, wherein the key includes two perpendicular engagement planes.

18. The apparatus of claim 13, further comprising a spring that mechanically couples the plug to the housing, wherein the spring biases the plug in the first position.

19. The apparatus of claim 13, further comprising a spring that mechanically couples the plug to the housing, wherein the spring biases the plug in the second position.

20. The apparatus of claim 13, further comprising an actuator that is at least partially positioned outside the housing and that is mechanically coupled to the plug, wherein the keyed lock is configured to selectively restrict movement of the actuator.

21. The apparatus of claim 13, wherein the plug includes a rubber gasket configured to seat against the housing when the plug is in the first position.

22. The apparatus of claim 13, wherein the key comprises an encoded card and the keyed lock is configured to read the encoded card.

23. An apparatus comprising:
a housing;
a fluid channel at least partially within the housing fluidly connecting a first port with a second port;
a seal that is positionable in a first position wherein the seal occludes the fluid channel, and in a second position wherein the first and second ports are fluidly connected; and
a lock assembly positioned at least partially within the housing, and adapted to restrict movement of the seal, such that when the lock assembly is in an unlocked position the seal is movable between the first and second positions, and when the lock assembly is in a locked position the seal is immobilized.

24. The apparatus of claim 23, wherein the lock assembly comprises a keyed lock with pins.

25. The apparatus of claim 23, further comprising a button actuator coupled to the seal, such that pressing the button actuator moves the seal from the first position into the second position.

26. The apparatus of claim 23, further comprising a button actuator coupled to the seal, wherein the lock assembly is configured to restrict movement of the button actuator.

27. The apparatus of claim 23, further comprising a spring that mechanically couples the seal to an inner surface of the fluid channel, the wherein the spring biases the seal in the first position.

28. The apparatus of claim 23, further comprising a spring that mechanically couples the seal to an inner surface of the fluid channel, the wherein the spring biases the seal in the second position.

29. The apparatus of claim 23, wherein the fluid channel is machined from a brass housing.

30. The apparatus of claim 23, wherein the fluid channel is machined from an aluminum housing.

31. The apparatus of claim 23, wherein the lock assembly is moved between the unlocked position and the locked position using a key.

32. The apparatus of claim 23, wherein the lock assembly is moved between unlocked position and the locked position using a key with two perpendicular engagement planes.

33. The apparatus of claim 23, wherein the lock assembly comprises a combination lock.

34. A faucet assembly comprising:
a fluid channel fluidly connecting a first port with a second port;
a plug that is movable between a first position and a second position, such that when the plug is in the first position the first port is fluidly connected to the second port, and when the plug is in the second position the channel is occluded; and
locking means for restricting movement of the plug.

35. The faucet assembly of claim 34, wherein the fluid channel is machined in a brass housing.

36. The faucet assembly of claim 34, wherein the fluid channel is machined in an aluminum housing.

37. The faucet assembly of claim 34, wherein the locking means comprises a mechanically keyed lock.

38. The faucet assembly of claim 34, wherein the locking means comprises an electronically keyed lock.

39. The faucet assembly of claim 34, wherein the locking means comprises a combination lock.

40. The faucet assembly of claim 34, further comprising means for biasing the plug in the second position.

41. A method of controlling fluid flow comprising:
providing a faucet assembly having a fluid channel with a fluid inlet port configured to be connected to a fluid source and a fluid outlet port configured to be connected to a spigot;
providing a plug that is positioned within the faucet assembly and that is capable of being moved between a first position and a second position with a switch, wherein moving the plug from the first position to the second position severs a hydraulic connection between the fluid inlet port and the fluid outlet port; and
providing a key to lock a locking mechanism, wherein locking the locking mechanism disables the switch, thereby preventing movement of the plug between the first position and the second position.

42. The method of claim 41, wherein the key is a dual-plane key.

43. The method of claim 41, wherein the key is a magnetically-encoded card.

44. The method of claim 41, further comprising biasing the plug in the second position.

45. The method of claim 41, further comprising biasing the plug in the second position using a spring that mechanically couples the plug with an interior surface of the fluid channel.

46. The method of claim 41, wherein the fluid outlet port is threadingly engaged to the spigot.

47. The method of claim 41, wherein the fluid inlet port is threadingly engaged to the fluid source.

48. The method of claim 41, wherein the fluid channel is machined in a brass housing.

49. The method of claim 41, wherein the switch is a button that, when pressed, moves the plug from the second position to the first position.

50. A method of manufacturing a faucet assembly, the method comprising:
providing a housing having a first port and a second port, wherein a channel passes through the housing from the first port to the second port;
positioning a plug within the housing, wherein the plug is movable between a closed position wherein the channel is occluded and an open position wherein the first port is fluidly connected to the second port;
coupling a switch to the plug, wherein a portion of the switch is positioned outside the housing, such that actuation of the switch causes the plug to move between the open position and the closed position; and
providing a keyed lock at least partially within the housing, wherein locking the keyed lock prevents movement of the switch.

51. The method of claim 50, further comprising coupling the plug to the housing with a spring, wherein the spring biases the plug in the closed position.

52. The method of claim 50, further comprising coupling the plug to the housing with a spring, wherein the spring biases the plug in the open position.

53. The method of claim 50, wherein the plug includes a gasket configured to seal the plug against an interior surface of the channel.

54. The method of claim 50, further comprising providing a key configured to lock and unlock the keyed lock, wherein the key comprises a dual-plane key.

55. The method of claim 50, further comprising providing a key configured to lock and unlock the keyed lock, wherein the key comprises a magnetically-encoded card.

56. The method of claim 50, wherein providing the housing comprises machining brass stock.

57. The method of claim 50, wherein providing the housing comprises sand casting molten brass.
